(19) United States
(12) Patent Application Publication
(10) Pub. No.: US 2004/0134975 A1
(43) Pub. Date: Jul. 15, 2004

(54) Composite pallet for a vector transient reflow process

(75) Inventors: Lakhi N. Goenka, Ann Arbor, MI (US); Brenda J. Nation, Troy, MI (US); Peter J. Sinkunas, Canton, MI (US); Mark Tor, Sterling Heights, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/340,058

(22) Filed: Jan. 10, 2003

(51) Int. Cl. B23K 31/00

(52) U.S. Cl. 228/248.1; 228/248.5

(57) ABSTRACT

The present invention involves a composite pallet for a substrate of a printed circuit board for a vector transient reflow process. The composite pallet includes a heat conductive layer for heat sinking means from the substrate and a heat insulative layer adjacent the conductive layer to shield the substrate from heat and to absorb heat from the heat conductive layer. The heat conductive layer has first and second opposite surfaces. The first surface is configured to receive the substrate disposed thereon to diffuse heat from the substrate during the vector transient reflow process. The heat insulative layer is disposed adjacent the second surface.

### BACKGROUND OF THE INVENTION

The present invention relates to a composite pallet for a vector transient reflow process of a substrate of a printed circuit board.

It is well known in the art to mount electronic components to rigid and flexible printed circuit boards. Typically, solder paste is applied to conductor pad regions on the rigid or flexible substrate. Components are then placed in their terminals contacting the solder paste in the pad regions. The substrate is then exposed to relatively high temperatures to activate the solder paste which melts and then solidifies to bond and electrically connect the components on to the substrate. The flexible substrates are typically made from polyimide, which exhibits good stability when exposed to high temperatures.

Moreover, pallets which receive and support the substrate during a vector transient reflow process are made of various materials, such as polymers, to absorb heat from the substrate. Manufacturers have been challenged in improving heat sinking means for transferring heat away from the substrate to lessen substrate degradation or warpage due to heat absorption. In many situations, at least a degree of substrate warpage or degradation is experienced due to the high temperatures. While the prior art teachings achieve their intended purpose, significant improvements are needed. For example, it is desirable to eliminate or lessen warpage on the substrate of the printed circuit board. In many situations, the substrate which typically is made of a plastic material, e.g., polyethylene terephthalate (PET), is heated to temperatures greater than 250° C. Without proper heat sinking means, the substrate may experience warpage or bending due to the high temperatures in the oven. As known, substrate warpage affects mechanical accuracies of the printed circuit board, mechanical properties of the substrate, and heat transfer capabilities of the printed circuit board.

### BRIEF SUMMARY OF THE INVENTION

Thus, it is an aspect of the present invention to provide a composite pallet for a vector transient reflow process of a substrate of a printed circuit board, wherein the composite pallet includes a plurality of layers providing heat shielding to the substrate.

It is another aspect of the present invention to provide a composite pallet for a vector transient reflow process of a printed circuit board substrate to allow for an improved heat transfer across the substrate.

One embodiment of the present invention includes an improved composite pallet for a vector transient reflow process of a substrate for a printed circuit board. The pallet includes a heat conductive layer for heat sinking means from the substrate and a heat insulative layer. The heat conductive layer has first and second opposite surfaces. The first surface is configured to receive the substrate disposed thereon to diffuse heat from the substrate during the vector transient reflow process. The heat insulative layer is disposed adjacent the second surface to shield the substrate from heat and to absorb heat from the heat conductive layer improving the heat transfer across the substrate.

Other objects and advantages of the present invention will become apparent upon considering the following detailed description and appended claims, and upon reference to the accompanying drawings.

### BRIEF DESCRIPTION OF THE DRAWINGS

FIG. 1 is a schematic representation of an apparatus for reflowing solder to electrically connect electronic components to a flexible substrate mounted on a composite pallet, in accordance with the present invention;

FIG. 2 is a cross-sectional view of a preferred embodiment of the composite pallet in accordance with the present invention;

FIG. 3 is a plan view of the composite pallet having a flexible substrate on which electronic components are mounted on both exposed sides of the substrate, in accordance with the present invention; and

FIG. 4 is a flowchart depicting one method of soldering electronic components to a substrate with a composite pallet for a vector transient reflow process in accordance with the present invention.

### DETAILED DESCRIPTION OF THE INVENTION

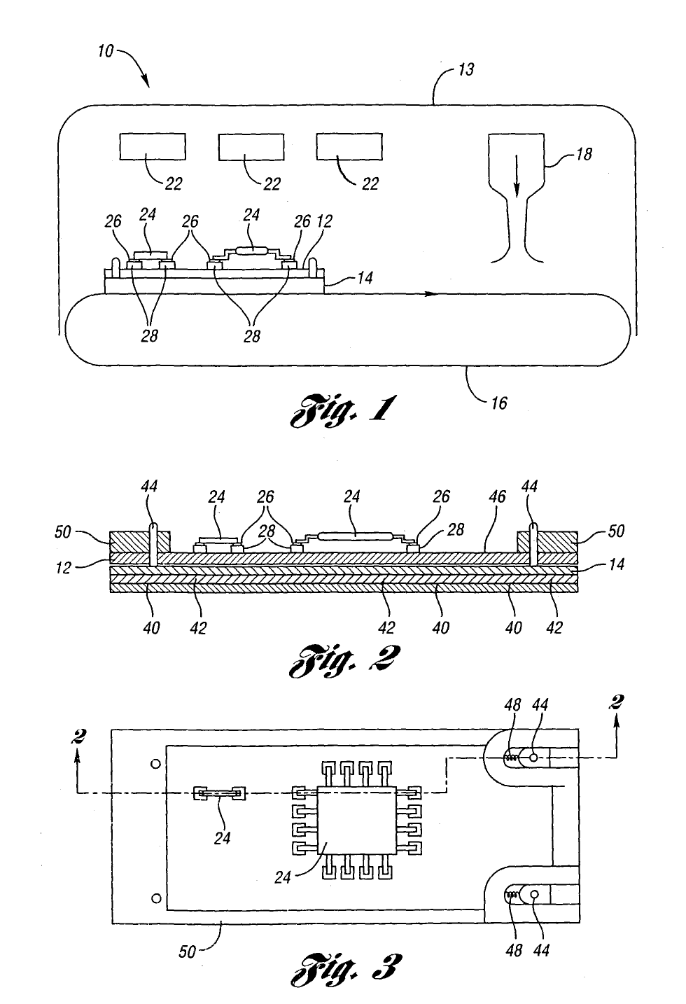

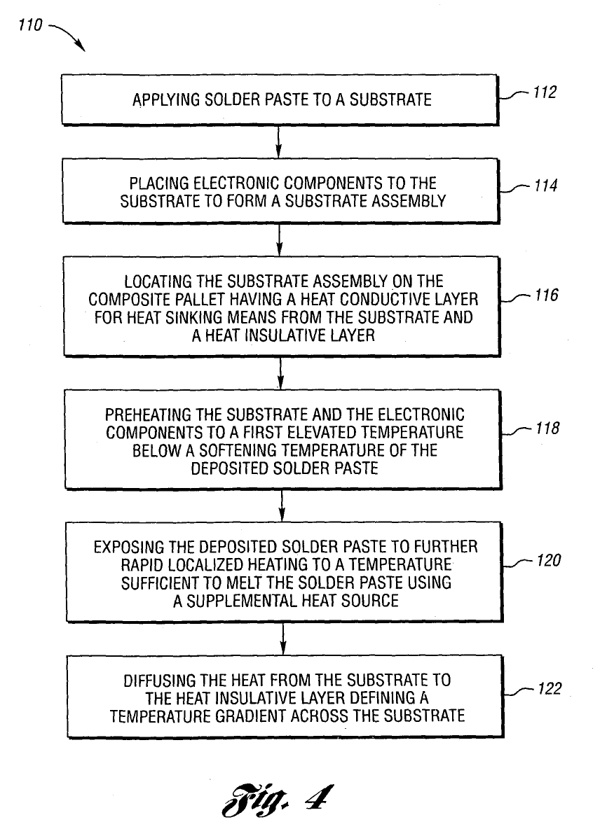

A system 10 for reflowing solder to electrically interconnect electronic components to a flexible or semi-flexible substrate 12 is illustrated in FIG. 1, in accordance with the present invention. Further, system 10 includes a pallet 20 that provides a means to mount circuit components on flexible substrate 12 without degrading the material properties of the substrate. System 10 additionally includes a reflow oven 13, a conveyor system 16, a gas nozzle 18 and a pallet 20. The reflow oven 13 has a plurality of heaters 22 to pre-heat the substrate 12 to a desired temperature. Conveyor system 16 is configured in a conventional manner to cooperatively receive pallets 14 for movement through the reflow oven 13.

A system and method for mounting electronic components on to flexible substrates are discussed in U.S. patent application serial No. 60/237,650, filed Oct. 3, 2000, and international patent application No. PCT/US01/31122, filed Oct. 3, 2001, both of which are incorporated herein by reference.

In this embodiment, pallet 14 is a composite pallet 14 for reflowing solder paste to interconnect electronic components 24 to flexible substrates 12, in accordance with the present invention. Composite pallet 14 is configured to support substrate 12 and cooperates with conveyor system 16 to transport substrate 12 through oven 13. Heaters 22 of oven 13 pre-heat substrate 12, and hot gas nozzle 18 provides supplemental heating. Solder paste 26 is printed on conductor pads 28 disposed on substrate 12 on which components 24 are placed.

As shown in FIG. 2, the composite pallet 14 includes a plurality of layers to receive a substrate for a printed circuit board in a vector transient reflow process in accordance with one embodiment of the present invention. The composite pallet 14 includes a heat conductive layer 30 for heat sinking means from the substrate 12. In this embodiment, the heat conductive layer 30 includes a conductive material which may include copper, aluminum, steel or any other suitable conductive material. The heat conductive layer 30 has first and second opposite surfaces 31, 32. As shown, the first surface 31 has a peripheral area 33 and is configured to receive the substrate 12 disposed thereon during the vector transient reflow process of the substrate 12.

It is to be noted that the material comprising the heat conductive layer 30 may include any other suitable material having diffusivity characteristics or conductive characteristics so that heat may be transferred from the substrate to protect the substrate from heat degradation.

The composite pallet 14 further comprises a heat insulative layer 34 disposed adjacent the second surface 32 for shielding the substrate from heat and for absorbing heat from the heat conductive layer 30. In this embodiment, the heat insulative layer 34 comprises a fire retardant epoxy laminate sheet, e.g., FR4. As shown, composite pallet 14 further includes a heat insulative peripheral member 36 disposed about the peripheral area 33 of the first surface 31 for peripheral heat shielding of the substrate 12. This provides protection of external heat transfer to the substrate during the vector transient reflow process. In this embodiment, the heat insulative peripheral member 36 includes a fire retardant epoxy laminate material, e.g., FR4, or any other suitable material for heat shielding a substrate.

It is to be noted that the heat insulative layer and the heat insulative peripheral member may be made of any other heat insulation material known in the art capable of absorbing heat from the heat conductive layer so that the substrate may be shielded from heat and heat may be transferred from the substrate.

In this embodiment, the composite pallet 14 further includes a balancing layer 38 disposed adjacent the heat insulative layer 34 opposite the heat conductive layer 30 for support of the pallet 14 during the vector transient reflow process of the substrate 12. In this embodiment, the balancing layer 38 comprises a conductive material which may include aluminum, steel, or copper, or any other suitable conductive material. It has been determined that the balancing layer provides support of the pallet during the vector transient reflow process to lessen warpage of the composite pallet. This is accomplished by providing a relatively even or balanced thermal expansion of the conductive material on both sides of the heat insulative layer 34. It has been found that by providing a relatively even or symmetrical thermal expansion of conductive material at both sides of the heat insulative layer, bending and arcuate formations of the heat insulative layer due to high temperature is lessened or avoided. Thus, a planar or straight composite pallet is a more likely result after the completion of the vector transient reflow process. Hence, longevity of the composite pallet is enhanced for further reuse of the composite pallet.

Referring to FIG. 2, a cross-sectional view of composite pallet 14 is illustrated, in accordance with the present invention. As shown pallet 14 includes at least one internal cavity 40 having therein a phase-change material 42. Support pins 44 are provided on pallet 14 to hold substrate 12 flat or planar on a pallet surface 46. Pins 44 may be tensioned or loaded by springs 48 to provide a tensioning force on substrate 12. In an embodiment of the present invention, a picture frame 50 may be used to secure substrate 12 against pallet surface 46. Picture frame 50, as illustrated attaches to and secures the periphery of substrate 12 to hold the edges of substrate 12 against surface 46 of the pallet.

In one embodiment of the present invention, substrate 12 is a polyester film having a thickness of 0.003 to 0.010 inches. Copper conductors 68 and solder pads 70 may be formed on both sides 60, 62 of the polyester substrate, as is well known in the art. A suitable solder mask (not shown) is applied over copper conductors 68 so that only the pad 70 areas on which solder paste 72 is to be printed are exposed. These pads 70 may have a suitable surface finish such as an organic surface finish to protect the pad surfaces from oxide formation. Other surface finishes such as immersion silver or electroplated tin may be used to enhance the solderability of components 24 to the pads.

Solder pastes 72 that have compositions containing lead, as well as solder pastes having lead-free compositions may be used. The solder pastes containing lead generally have a lower melting temperature of about 183° to 200° C., while lead-free solder compositions have melting temperatures of about 220° to 245° C.

In operation, as pallet 14 having substrate 12 affixed thereon is transported through the pre-heat zones in oven, the solder paste 72 is activated and gradually heated to just below its melting temperature. During this process, the heat conductive layer and heat insulative layer begin to absorb heat from the oven 13 as well as from the substrate 12, which thereby lowers the temperature of the substrate. The supplemental heat created from gas nozzle 18 is utilized to provide a focused and concentrated heat source. Gas nozzle 18 provides heat to the exposed substrate surface for a short duration. The solder paste 26, conductor pads 28, and copper regions of substrate preferable absorb heat because of their high thermal diffusivity, while substrate 12 is maintained at a lower temperature by the pallet 14, which is held at a lower temperature by the heat conductive layer and heat insulative layer. In this manner, softening and damage to substrate 12 during the reflow process is prevented or lessened.

After the exposed region of the substrate passes below gas nozzle 18, the temperature of the exposed electronic component 24 and substrate 12 rapidly falls so that the activated solder cools and solidifies. A reliable electrical connection between the conductors or pads 20 and components 24 is thus formed.

The foregoing discussion discloses and describes the preferred embodiment of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

1. A composite pallet for a vector transient reflow process of a substrate for a printed circuit board, the pallet comprising:
a heat conductive layer for heat sinking means from the substrate, the heat conductive layer having first and second opposite surfaces, the first surface being configured to receive the substrate disposed thereon to diffuse heat from the substrate during the vector transient reflow process; and
a heat insulative layer adjacent the second surface to shield the substrate from heat and to absorb heat from the heat conductive layer.

2. The composite pallet of claim 1 wherein the first surface of the heat conductive layer has a peripheral area.

3. The composite pallet of claim 2 further comprising a heat insulative peripheral member disposed about the peripheral area of the first surface for peripheral heat shielding of the substrate.

4. The composite pallet of claim 1 further comprising a balancing layer disposed adjacent the heat insulative layer opposite the conductive layer for support of the pallet during the vector transient reflow process of the substrate.

5. The composite pallet of claim 1 wherein the heat conductive layer includes a conductive material.

6. The composite pallet of claim 5 wherein the conductive material includes copper, aluminum, and steel.

7. The composite pallet of claim 1 wherein the heat insulative layer comprises a fire retardant epoxy material.

8. The composite pallet of claim 3 wherein the heat insulative peripheral member comprises a fire retardant epoxy material.

9. The composite pallet of claim 4 wherein the balancing layer comprises a conductive material.

10. The composite pallet of claim 9 wherein the conductive material includes copper, aluminum, and steel.

11. A composite pallet for a vector transient reflow process of a substrate for a printed circuit board, the pallet comprising:
a heat conductive layer for heat sinking means from the substrate, the heat conductive layer having first and second opposite surfaces, the first surface having a peripheral area and being configured to receive the substrate disposed thereon during the vector transient reflow process of the substrate;
a heat insulative layer adjacent the second surface for shielding the substrate from heat and for absorbing heat from the heat conductive layer;
a heat insulative peripheral member disposed about the peripheral area of the first surface for peripheral heat shielding of the substrate; and
a balancing layer disposed adjacent the heat insulative layer opposite the heat conductive layer for support of the pallet during the vector transient reflow process of the substrate.

12. The composite pallet of claim 11 wherein the heat conductive layer includes a conductive material.

13. The composite pallet of claim 12 wherein the conductive material includes copper, aluminum, and steel.

14. The composite pallet of claim 11 wherein the heat insulative layer comprises a fire retardant epoxy laminate sheet.

15. The composite pallet of claim 11 wherein the heat insulative peripheral member comprises a fire retardant epoxy laminate material.

16. The composite pallet of claim 11 wherein the balancing layer comprises a conductive material.

17. The composite pallet of claim 16 wherein the conductive material includes aluminum, steel, and copper.

18. A method of soldering electronic components to a substrate with a composite pallet for a vector transient reflow process, the method comprising:
applying solder paste to the substrate;
placing electronic components to the substrate to form a substrate assembly;
locating the substrate assembly on the composite pallet having a heat conductive layer for heat sinking means from the substrate and a heat insulative layer, the heat conductive layer having first and second opposite surfaces, the first surface being configured to receive the substrate disposed thereon to diffuse heat from the substrate during the vector transient reflow process, the heat insulative layer being adjacent the second surface to shield the substrate from heat and to absorb heat from the heat conductive layer;
preheating the substrate and the electronic components to a first elevated temperature below a softening temperature of the deposited solder paste;
exposing the deposited solder paste to further rapid localized heating to a temperature sufficient to melt the solder paste using a supplemental heat source; and
diffusing the heat from the substrate to the composite pallet defining a temperature gradient across the substrate.

19. The method of claim 18 further comprising directing hot gas on to the substrate using a gas nozzle.

20. The method of claim 18 further comprising transporting the pallet under a supplemental heat source using a conveyer.

21. The method of claim 18 wherein the temperature gradient is up to about 45° C.
